(19) United States
(12) Patent Application Publication
(10) Pub. No.: US 2026/0196128 A1
(43) Pub. Date: Jul. 9, 2026

(54) TRAFFIC INFORMATION PREDICTION APPARATUS AND METHOD

(71) Applicant: HYUNDAI AUTOEVER CORP., Seoul (KR)

(72) Inventors: Sang Kyu SON, Seoul (KR); Jeong Hun LEE, Seoul (KR); Ah Young KANG, Seoul (KR); Mi Kyeong LEE, Seoul (KR)

(21) Appl. No.: 19/432,595

(22) Filed: Dec. 24, 2025

(30) Foreign Application Priority Data
Jan. 3, 2025 (KR) 10-2025-0001121

(51) Int. Cl. G08G 1/01; G08G 1/052

(52) U.S. Cl. CPC G08G 1/0133; G08G 1/0129; G08G 1/0145; G08G 1/052

(57) ABSTRACT

Traffic information prediction apparatus and methods are described. According to one embodiment, a traffic information prediction apparatus includes a communication unit configured to receive real-time traffic information data and past traffic information data and a processor configured to set a link group including a plurality of links, predict, using a first artificial intelligence model, a travel time for the link group based on the real-time traffic information data and the past traffic information data, and predict, using a second artificial intelligence model, link-level traffic information based on the predicted travel time for the link group.

### CROSS-REFERENCE TO RELATED APPLICATION

This application claims priority from and the benefit of Korean Patent Application No. 10-2025-0001121, filed on January 3, 2025, which is hereby incorporated by reference for all purposes as if set forth herein.

### BACKGROUND

### FIELD

The present disclosure relates to a traffic information prediction apparatus and method, which collect real-time data and then predict traffic information based on Estimated Time of Arrival (ETA).

### DISCUSSION OF THE BACKGROUND

Generally, a navigation device mounted in a vehicle provides map information and guides a route to a destination based on the map.

Such a navigation device determines its current position based on location information of a vehicle received through Global Positioning System (GPS) satellites, and thereafter reads data about the current position from an internal road database (DB) or a received road DB to display the read data together with the position of the vehicle on the screen.

Recently, the navigation device may not only set a route and provide guidance along the route, but may also compute an estimated time of arrival for the vehicle to reach the destination based on traffic conditions and provide the estimated time of arrival to a user.

In this case, the navigation device may not only request route searching from a server for route exploration, but may also receive data from a device that manages and analyzes traffic conditions, and may compute an estimated time of arrival based on the received data.

However, the prediction of the estimated time of arrival uses the entry and exit times of a vehicle measured on a link basis, and is problematic in that the accuracy of a predicted travel time for each link is low due to the variability of link-level data. In particular, the link-level data is limited in deriving patterns for predicting the required time.

### SUMMARY

An object of the present disclosure is to provide a traffic information prediction apparatus and method, which compute a travel time for each link group unit by setting a link group including a plurality of links, and predict traffic information on a link basis based on the travel time.

A traffic information prediction apparatus according to one aspect of the present disclosure includes a communication unit configured to receive real-time traffic information data and past traffic information data; and a processor configured to set a link group including a plurality of links, predict a travel time or estimated time of arrival (ETA) for the link group using a first artificial intelligence model based on the real-time traffic information data and the past traffic information data, and predict link-level traffic information using a second artificial intelligence model based on the predicted travel time (ETA) for the link group.

The processor may be configured to input traffic information data including speed, traffic volume, incident, and location information to the first artificial intelligence model and the second artificial intelligence model, and input link group-level predicted travel time (ETA) computed from the first artificial intelligence model to the second artificial intelligence model and then output link-level predicted traffic information.

The processor may compute the travel time (ETA) for the link group by summing travel times (ETA) for the plurality of links at an identical n-th time through the first artificial intelligence model.

The processor may compute a predicted speed for the link group by converting the travel time (ETA) for the link group into a speed based on the first artificial intelligence model.

The processor may predict the link-level traffic information using a traffic information heatmap for the plurality of links included in the link group based on the second artificial intelligence model.

The processor may input link attribute information that includes spatial information, link information, traffic information, and incident information, and link group attribute information that includes length information, traffic information, and time information to the first artificial intelligence model and the second artificial intelligence model.

The first artificial intelligence model and the second artificial intelligence model may be implemented by modeling traffic information data based on an embedding module and a transformer module.

The transformer module may learn importance of each link, among the plurality of links included in the link group, based on a degree of influence on traffic condition prediction.

A traffic information prediction method according to another aspect of the present disclosure includes predicting, by a processor, a travel time (ETA) for a link group using a first artificial intelligence model based on real-time traffic information data and past traffic information data; and predicting, by the processor, link-level traffic information using a second artificial intelligence model based on the travel time (ETA) for the link group.

In the predicting of the travel time (ETA) for the link group, the processor may compute the travel time (ETA) for the link group by summing travel times (ETA) for respective links at an identical n-th time, for the plurality of links included in the link group, through the first artificial intelligence model.

In the predicting of the travel time (ETA) for the link group, the processor may compute a predicted speed for the link group by converting the travel time (ETA) for the link group into a speed based on the first artificial intelligence model.

In the predicting of the link-level traffic information, the processor may predict the link-level traffic information using a traffic information heatmap for the plurality of links included in the link group based on the second artificial intelligence model.

The traffic information prediction method may further include inputting, by the processor, link attribute information that includes spatial information, link information, traffic information, and incident information, and link group attribute information that includes length information, traffic information, and time information to the first artificial intelligence model and the second artificial intelligence model.

In the inputting, the processor may be configured to input traffic information data including speed, traffic volume, incident, and location information to the first artificial intelligence model and the second artificial intelligence model, and input the link group-level predicted ETA computed from the first artificial intelligence model to the second artificial intelligence model.

The first artificial intelligence model and the second artificial intelligence model may be implemented by modeling traffic information data based on an embedding module and a transformer module.

The transformer module may learn importance of each link, among the plurality of links included in the link group, based on a degree of influence on traffic condition prediction.

According to the present disclosure, the traffic information prediction apparatus and method according to an embodiment of the present disclosure may predict a travel time by analyzing the entry and exit of a vehicle on a link group basis, and may convert the predicted travel time into a link level, thus improving prediction accuracy.

The traffic information prediction apparatus and method according to the present disclosure may easily derive a pattern for traffic conditions and easily predict traffic information on a link basis by analyzing real-time data on a link group basis.

The traffic information prediction apparatus and method according to the present disclosure may provide accurate traffic information, thus improving the ease and efficiency of route setting.

### BRIEF DESCRIPTION OF THE DRAWINGS

FIG. 1 is a diagram illustrating in brief the configuration of a system including a traffic information prediction apparatus according to an embodiment of the present disclosure.

FIG. 2 is a block configuration diagram illustrating in brief the control configuration of a traffic information prediction apparatus according to an embodiment of the present disclosure.

FIG. 3 is a diagram referenced to describe traffic information prediction using an artificial intelligence model of a traffic information prediction apparatus according to an embodiment of the present disclosure.

FIG. 4 is a diagram illustrating a process of predicting traffic information on a link group basis in a traffic information prediction apparatus according to an embodiment of the present disclosure.

FIG. 5 is a diagram illustrating a process of converting link group-based traffic information into link-level traffic information in a traffic information prediction apparatus according to an embodiment of the present disclosure.

FIG. 6 is an example diagram illustrating an artificial intelligence model of a traffic information prediction apparatus according to an embodiment of the present disclosure.

FIG. 7 is a flowchart illustrating a traffic information prediction method of a traffic information prediction apparatus according to an embodiment of the present disclosure.

### DETAILED DESCRIPTION OF THE ILLUSTRATED EMBODIMENTS

Hereinafter, the present disclosure will be described with reference to the attached drawings.

In this process, the thickness of lines or the sizes of components illustrated in the drawings may be exaggerated for clarity and convenience of description. Further, the terms described below are defined in consideration of the functions in the present disclosure, and may vary depending on the intent or conventions of a user or operator. Therefore, these terms should be defined based on the entire contents of the present specification.

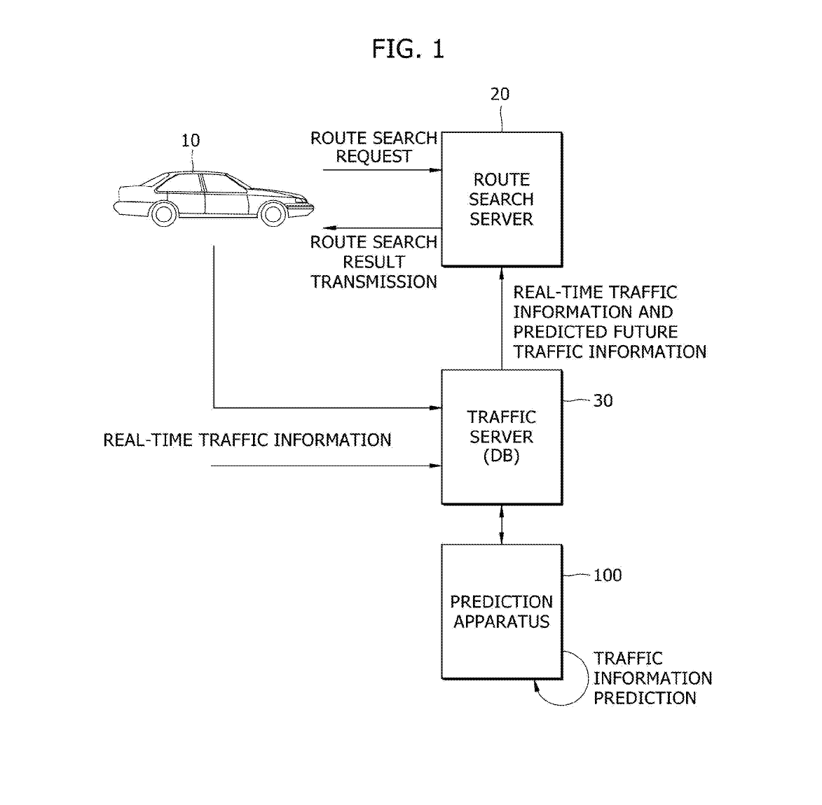

FIG. 1 is a diagram illustrating in brief the configuration of a system including a traffic information prediction apparatus according to an embodiment of the present disclosure.

Referring to FIG. 1, a system including a traffic information prediction apparatus according to the present disclosure may include a vehicle 10, a route search server 20, a traffic server 30, and a prediction apparatus 100.

The vehicle 10 may request the route search server 20 to search for a route through a navigation terminal.

The route search server 20 may request data from the traffic server 30 in response to a route search request received from the vehicle 10, and may receive real-time traffic information and predicted future traffic information.

Here, the traffic server 30 may store, in a database (DB), data regarding road information, road facilities installed on roads, and links. The traffic server 30 may store real-time traffic information received in real time from the position sensor of the vehicle 10 or road facilities, and may provide traffic information in response to a request from the route search server 20. For example, the road facilities are configured to collect information about roads and traffic conditions, and include a Closed-Circuit Television (CCTV), a Road Weather Information System (RWIS), a Vehicle Detection System (VDS), a Variable Message Sign (VMS), a Ramp Metering System (RMS), a Lane Control System (LCS), etc.

The traffic server 30 may provide data regarding road conditions and traffic conditions to the vehicle 10 and the route search server 20. Here, the traffic server 30 may include a database (DB) which stores data.

The prediction apparatus 100 may be connected to the traffic server 30, may set a plurality of links set on each road as a link group, and may predict traffic information for a future time point by analyzing real-time traffic information on a link group basis using the real-time traffic information.

The prediction apparatus 100 may predict a travel time (also referred to as “ETA: Estimated Time of Arrival) for a future time point on a link group basis, convert the predicted travel time into link-level information, and generate link-level predicted traffic information. The prediction apparatus 100 provides the link-level predicted traffic information to the traffic server 30. In some cases, the prediction apparatus 100 may be included in the traffic server 30.

Accordingly, the traffic server 30 may provide the link-level predicted traffic information to the route search server 20.

The route search server 20 may set a plurality of routes based on the predicted traffic information data received from the traffic server 30, compute an estimated time of arrival predicted for each route, and provide the results of computation to the navigation terminal of the vehicle 10.

Accordingly, the vehicle 10 may display each received travel route and the estimated time of arrival on the screen of the navigation terminal.

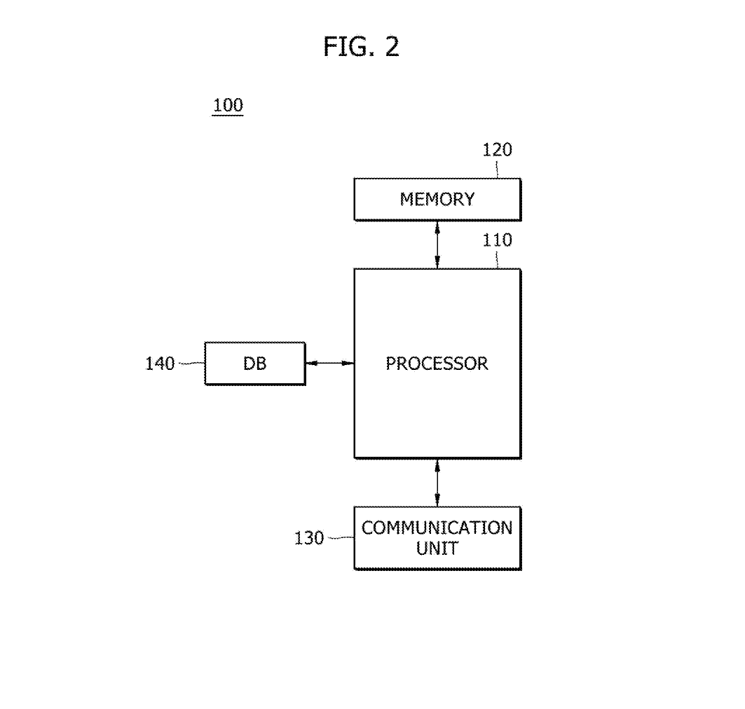

FIG. 2 is a block configuration diagram illustrating in brief the control configuration of a traffic information prediction apparatus according to an embodiment of the present disclosure.

Referring to FIG. 2, the prediction apparatus 100 may include memory 120, a communication unit 130, and a processor 110. Also, the prediction apparatus 100 may further include an artificial intelligence model, and a separate database (DB) 140 for training data for the artificial intelligence model.

The memory 120 may store data transmitted/received through the communication unit 130, artificial intelligence model data, and analysis data of the processor 110. Further, the memory 120 may temporarily store the training data for the artificial intelligence model and real-time traffic information received from the traffic server 30. The memory 120 may include a storage means including volatile memory such as a Random Access Memory (RAM), and nonvolatile memory such as a Read Only Memory (ROM), an Electrically Erasable Programmable ROM (EEPROM), or a flash memory.

The database 140 may store large-capacity data for predicting traffic information of the artificial intelligence model. For example, the database 140 may store training data for the artificial intelligence model, real-time traffic information data and past traffic information data that are received from the traffic server 30, and the link group-level travel time data predicted by the artificial intelligence model, and link-level predicted traffic information data.

The communication unit 130 may receive data stored in the traffic server 30 while communicating with the traffic server 30, and may transmit data computed by the processor 110 to the traffic server 30. The communication unit 130 may communicate with a previously registered terminal or the vehicle 10.

The communication unit 130 may communicate with the traffic server 30 by including a wired or wireless communication module, and may transmit or receive data using a communication bus of the traffic server 30 within the traffic server 30 in some cases. For example, the communication unit 130 may perform communication through at least one of short-range communication such as Wi-Fi or Bluetooth, mobile communication, Wireless Access in Vehicular Environment (WAVE) for communication with vehicles and road facilities, and Vehicle to Everything (V2X) for vehicle-to-object communication, and may also transmit or receive data through either Controller Area Network (CAN) communication or Local Interconnect Network (LIN) communication.

The processor 110 may include at least one microprocessor. The processor 110 may operate based on data stored in the memory and algorithm data.

The processor 110 may learn past traffic information and real-time traffic information based on the artificial intelligence model, and may predict future traffic information. The processor 110 may store data in the database 140 upon predicting traffic information using the artificial intelligence model, may load data to the memory 120, may process the data in real time, and may store the predicted traffic information in the database (DB) 140.

The processor 110 may set a link group including a plurality of links based on links set at a plurality of positions on the road. The processor 110 may set links included in a certain area unit or a relevant area as a single link group. Furthermore, for a section that is set based on a region or the like when the route of the vehicle 10 is established, the processor 110 may set a plurality of links included in the section as a link group.

The processor 110 may classify traffic information data collected from each link, and may predict a link group-level travel time (ETA) by inputting past traffic information data and real-time traffic information data for each link group into a first artificial intelligence model that is an artificial intelligence model for link groups.

Here, the processor 110 may predict the travel time (ETA) by deriving a pattern for link group-level traffic information based on the first artificial intelligence model. The predicted travel time (ETA) may include information regarding the travel time (ETA) at a future time point for a vehicle traveling through the corresponding link group.

The processor 110 may input link attribute information and link group attribute information, as input data, to the first artificial intelligence model and compute travel times (ETA) for respective links at an interval of a certain time for a future time point with respect to a prediction time point, and may compute a predicted travel time (ETA) for each link group by summing the travel times (ETA) for respective links for the future time point.

Further, the processor 110 predicts the travel time (ETA) at the link group level, and then inputs the link group-level travel time (ETA) to a second artificial intelligence model, thus computing link-level predicted traffic information from the link group-level travel time (ETA). The processor 110 may compute predicted traffic information at a future time point for each link, for the plurality of links included in the link group.

The processor 110 may retrain the first artificial intelligence model and the second artificial intelligence model based on the predicted traffic information.

The processor 110 may store pattern data of the travel time (ETA) at the link group level, predicted travel time (ETA) at the link group level, and link-level predicted traffic information in the database 140. Furthermore, the processor 110 transmits the link-level predicted traffic information, among pieces of the stored data, to the traffic server 30 through the communication unit 130.

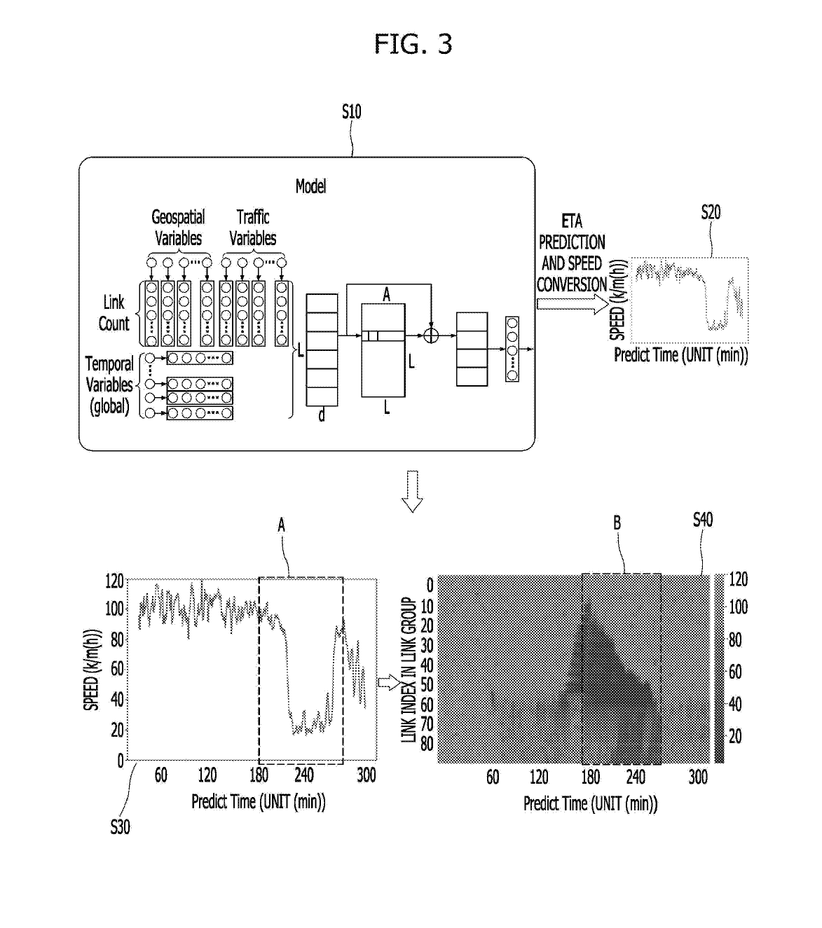

FIG. 3 is a diagram referenced to describe traffic information prediction using an artificial intelligence model of a traffic information prediction apparatus according to an embodiment of the present disclosure.

Referring to FIG. 3, the prediction apparatus 100 may set a link group including a plurality of links, and may compute predicted traffic information for the link group.

The processor 110 may set the link group based on at least one of a certain section, an area, and a junction according to route setting, with reference to national highways or roads. For example, when setting a route from Seoul to Busan, the processor 110 may set at least one link group including a plurality of links around a plurality of reference points such as the Seoul Tollgate, Dongtan, Anseong, Cheonan, Nami, Hoedeok, Biryong, Yeongdong, Gimcheon, Dongdaegu, and Yeongcheon.

The processor 110 may predict traffic information for a future time using a first artificial intelligence model for the link group. The processor 110 may predict link group-level travel time (ETA) through the first artificial intelligence model in step S10, convert the predicted value into a speed value, and output the speed value in step S20. For example, the processor 110 may predict traffic information for future time points by predicting the travel time (ETA) for a 5-hour period at 5-minute intervals.

Here, the processor 110 may compute travel times (ETA) at an n-th time corresponding to a future time point for the plurality of links included in the link group through the first artificial intelligence model, and may compute the travel time (ETA) for the link group by summing the travel times for respective links at the n-th time. That is, the processor 110 computes travel time for the link group by summing travel time for link A and travel time for link B at a first time, rather than the travel time for link A at the first time and the travel time for link B at a second time.

The processor 110 may convert the predicted travel time (ETA) for the link group into speed and input the speed into the second artificial intelligence model in step S30, and may convert a link group level into a link level and compute link-level predicted traffic information in step S40.

The processor 110 may generate link-level predicted speeds for the plurality of links included in the link group using the second artificial intelligence model, and may compute the link-level predicted speeds as link-level predicted traffic information.

The prediction apparatus 100 compares past data with real-time data using the two artificial intelligence models, and derives a pattern on a link group basis, thus predicting the travel time (ETA) required to pass through the link group. Here, the prediction apparatus 100 may compute the travel time (ETA) on a link basis based on past traffic information data for a plurality of links included in each link group.

Here, the prediction apparatus 100 may predict traffic information on a link basis by reflecting speed-reduction section B on a link basis in section A in which speed decreases due to traffic congestion or the like.

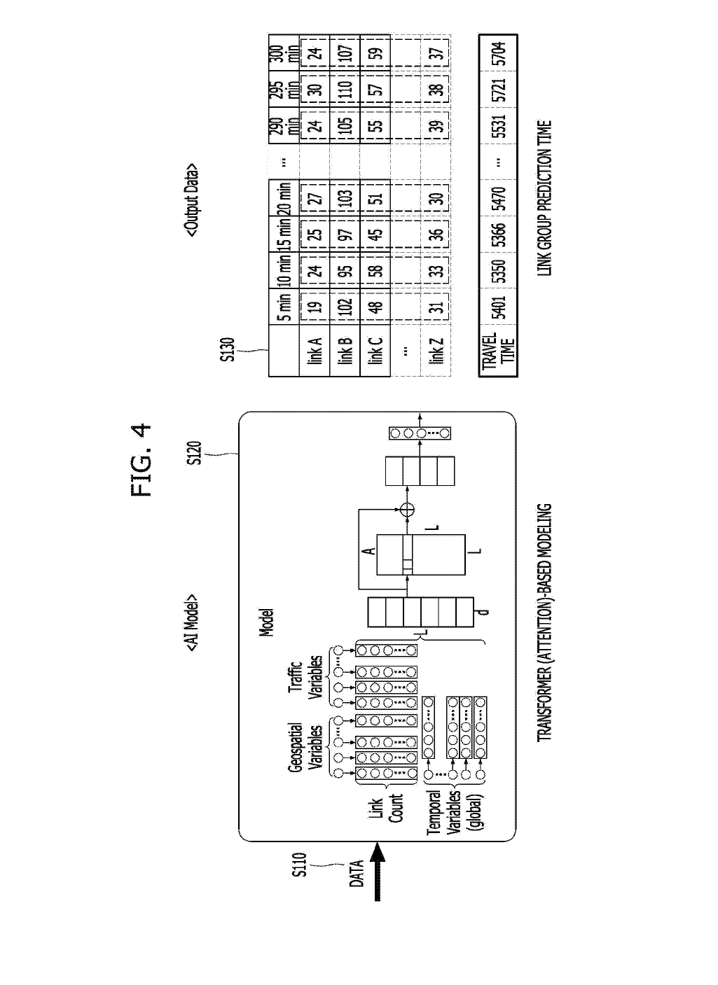

FIG. 4 is a diagram illustrating a process of predicting traffic information on a link group basis in a traffic information prediction apparatus according to an embodiment of the present disclosure.

Referring to FIG. 4, the processor 110 may compute a travel time (ETA) for a link group based on a first artificial intelligence model. The processor 110 may collect data in step S110, may input the data to the first artificial intelligence model in step S120, and may compute predicted travel time (ETA) for each link group by summing travel times for respective links at intervals of a certain time corresponding to a future time point in step S130.

The processor 110 may input the link-level traffic information, as input data, to the first artificial intelligence model. For example, the traffic information may include speed, traffic volume, incidents, and location information.

Because future congestion may vary depending on changes in traffic volume for past times, the processor 110 may predict traffic information more accurately by inputting data including past traffic volume information and real-time traffic volume information into the first artificial intelligence model.

Here, the processor 110 may utilize link attribute information and link group attribute information for the traffic information as the input data of the first artificial intelligence model.

The link attribute information may include spatial information, link information, traffic information, and incident information. The spatial information may be static or dynamic location information for each link, the link information may include links for respective road types and link lengths, the traffic information may include real-time rotation speed, past rotation speed data, and traffic volume, and the incident information may include incident information (accident alerts, construction information, and event or assembly information) for links included in the route.

The link group attribute information may include length information, traffic information, and time information. The length information may include the route length and the straight-line distance between an origin and a destination (Origin-Destination: OD), the traffic information may include real-time rotation speed, past rotation speed, and traffic volume, and the time information may include day-of-week information for the start of travel and a travel-start time point (one-minute interval) on a daily or weekly basis.

The first artificial intelligence model may be implemented by modeling traffic information based on a linear transformer, and may be generated through attention modeling that processes information by focusing on a specific portion. The first artificial intelligence model may convert input data into a vector, compute similarity, and compute an attention weight. The first artificial intelligence model may compute a weighted sum by multiplying the attention weight by the vector.

Accordingly, the first artificial intelligence model predicts, for each link group, the travel times for respective links over a future 5-hour period at 5-minute intervals, such as 5 minutes, 10 minutes, and 15 minutes. The processor 110 may sum travel times for the plurality of links at an n-th time that is a specific future time point in such a way as to sum travel times for respective links at a first time that is a future time point and sum travel times for respective links at a second time that is a future time point, for each link in the link group based on the output prediction results, thereby outputting a link group-level predicted travel time (ETA). That is, the link group-level travel time (ETA) may be computed by summing the travel times for respective links at the same n-th time.

For example, when link A, link B to link Z are included in the link group, the processor 110 may predict the travel time (ETA) for the link group at the 5-minute future time point by summing the travel time (ETA) for link A, the travel time (ETA) for link B, and the travel time (ETA) for link Z at the 5-minute future time point using the first artificial intelligence model.

In this way, the processor 110 may compute traffic information of the link group over a 5-hour period at 5-minute intervals for the future time. Because the processor 110 uses real-time data as input data, traffic congestion may be reflected in prediction results.

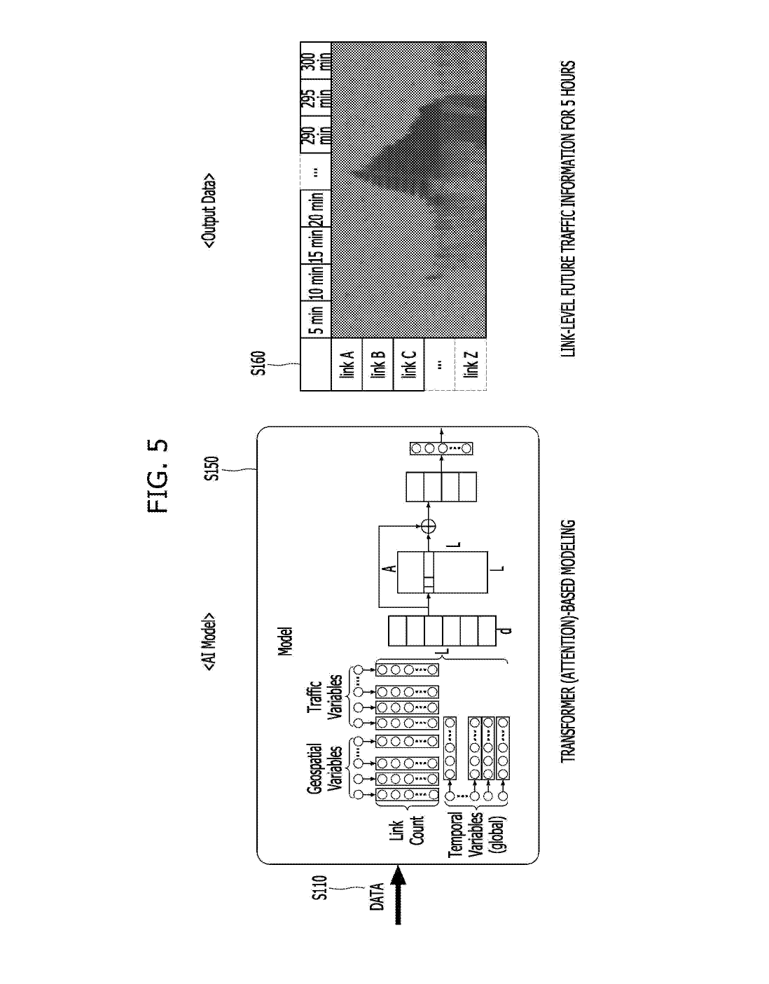

FIG. 5 is a diagram illustrating a process of converting link group-based traffic information into link-level traffic information in a traffic information prediction apparatus according to an embodiment of the present disclosure.

Referring to FIG. 5, the processor 110 may output link group-level predicted travel time (ETA) by computing link group-level travel time (ETA) for each future time point using the first artificial intelligence model, and may then compute link-level predicted traffic information by inputting the link group-level travel time (ETA) to the second artificial intelligence model.

The processor 110 may convert the link group-level travel time for each future time point into speed, and may convert the speed into traffic information for each link included in the link group or extract a pattern.

Here, the processor 110 may input the link attribute information and the link group attribute information, as input data, to the second artificial intelligence model, and may additionally input the predicted travel time (ETA) to the second artificial intelligence model. The predicted travel time (ETA) is a predicted link group-level travel time for each future time point, and is link group-level predicted traffic information previously computed by the first artificial intelligence model.

Similar to the first artificial intelligence model, the second artificial intelligence model may be implemented by modeling traffic information based on a linear transformer, and may be generated through attention modeling that processes information by focusing on a specific portion. Here, the second artificial intelligence model may predict link-level traffic information based on a traffic information heatmap for a plurality of links included in the link group.

The second artificial intelligence model may be generated by learning data about the plurality of links included in the link group. The second artificial intelligence model may not only learn the traffic information on a link basis, but may also compute a more accurately predicted value using data generated through learning performed on a link group basis.

The second artificial intelligence model may predict link-level travel time in consideration of link contribute information and link group attribute information in the link group-level predicted travel time, that is, travel time for a first time point, travel time for a second time point, to travel time for an m-th time point.

Accordingly, the second artificial intelligence model may predict traffic information including the travel times for each future time point on a link basis. For example, the link-level predicted traffic information may include predicted values (travel times or speeds) over a maximum of 5-hour period obtained by predicting traffic information at 5-minute intervals as link-level future time points.

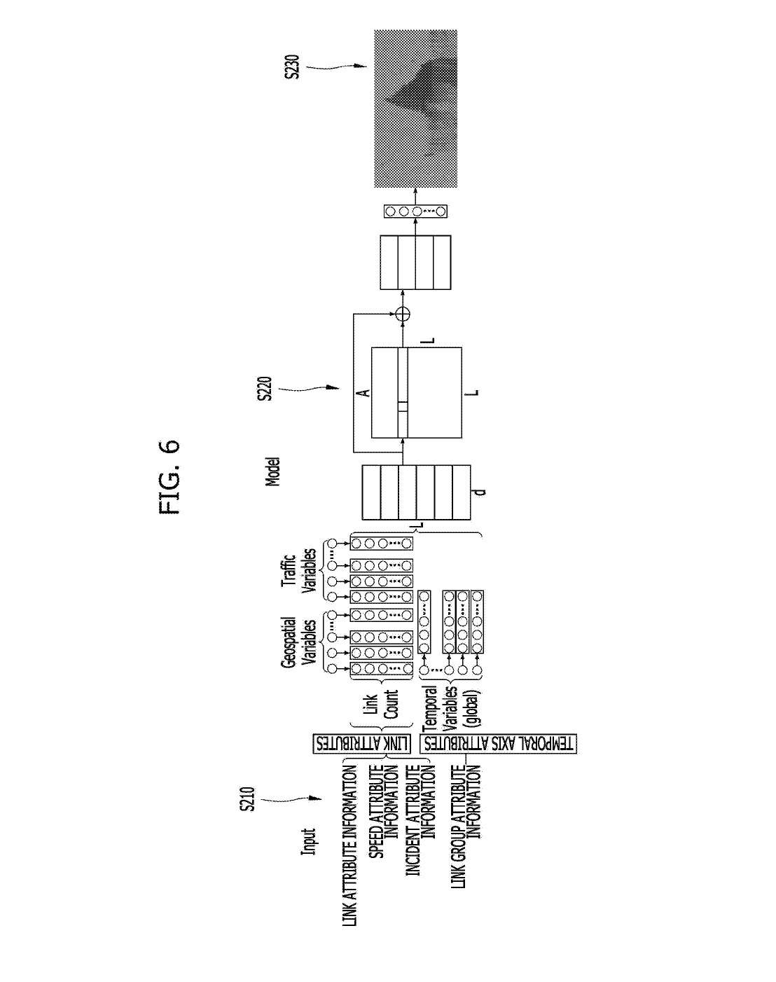

FIG. 6 is an example diagram illustrating an artificial intelligence model of a traffic information prediction apparatus according to an embodiment of the present disclosure.

Referring to FIG. 6, the processor 110 may predict travel time (ETA) on a link group basis by utilizing two artificial intelligence models, and predict again traffic information on a link basis, thus accurately predicting future traffic information.

Each of the artificial intelligence models receives link attribute information, speed attribute information, incident attribute information, and link group attribute information in step S210, analyzes data through an embedding module and a transformer module in step S220, and outputs predicted values in step S230.

The artificial intelligence models may be divided into an embedding module and a linear transformer (attention) module.

The embedding module is configured to extract feature vectors for respective features of traffic information and to concatenate multiple strings after the feature vectors of features are extracted for the link attributes. Also, the embedding module may extract feature vectors for respective features for link group attributes, and may generate two-dimensional (2D) data (X_{emb}) for link attributes and link group attributes.

The embedding module applies geospatial variables and traffic variables to a link count for the link attribute information among pieces of input data, and computes temporal variables for the link group attribute information, thereby generating 2D data (X_{emb}) with respect to the links and time. For example, the 2D data (X_{emb}) may include Link-1 X_{emb1}, Link-1 X_{emb3}, …, Link-1 X_{embN}, Temporal X_{embN+1}, etc.

The linear transformer module employs linear attention, which has a time complexity of O(n) and requires relatively small memory usage and computational cost. Because the linear transformer module generates the 2D data (X_{emb}) of the embedding module on a link basis, the corresponding attention learns the importance (linear link attention) of which links have a greater influence on future traffic condition prediction, rather than learning the importance of features.

That is, the transformer module may learn a link which greatly influences prediction of traffic conditions by applying an attention weight to the 2D data (X_{emb}). In this case, the linear transformer module may apply the weight (A) (where weight Aᵢⱼ ∈[0.1]) to an iₜₕX_{emb}, and sum the results thereof to output a function f(X_{emb}). The function f(X_{emb}) may include (AV)₁+X_{emb1}, (AV)₂+X_{emb2}, and the like.

Accordingly, the first artificial intelligence model may predict travel time (ETA) on a link group basis, and the second artificial intelligence model may predict link-level traffic information based on the predicted ETA.

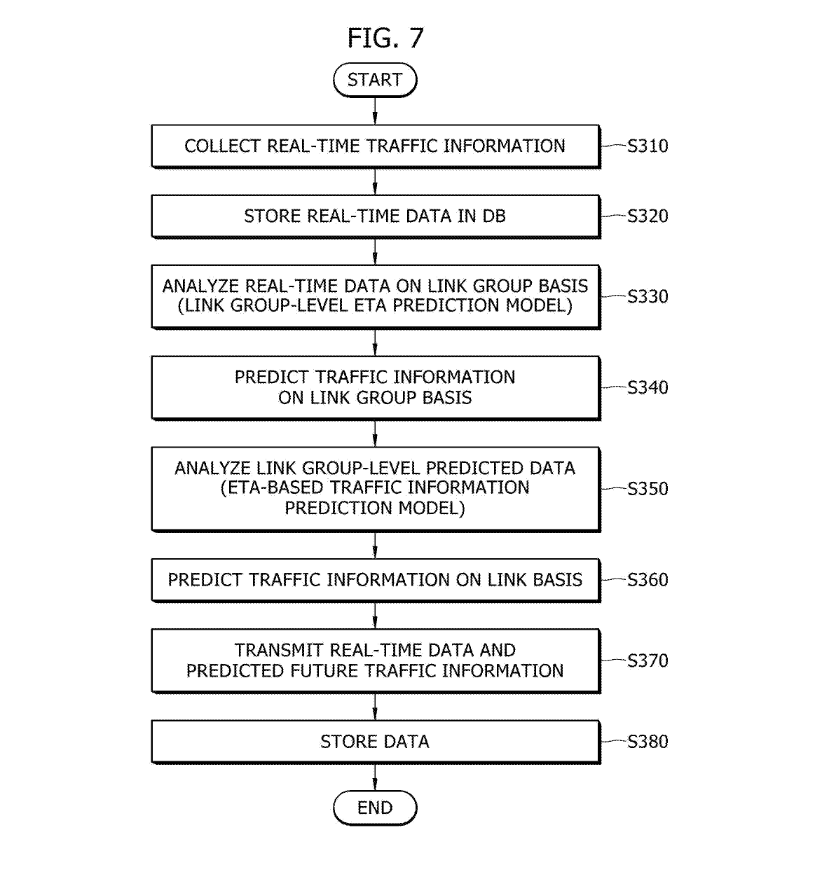

FIG. 7 is a flowchart illustrating a traffic information prediction method of a traffic information prediction apparatus according to an embodiment of the present disclosure.

Referring to FIG. 7, the prediction apparatus 100 is connected to a traffic server 30, and receives data for traffic information prediction from the traffic server 30.

The processor 110 collects past traffic information data and real-time traffic information data from the traffic server 30 in step S310. The processor 110 stores the past traffic information data and the real-time traffic information data in the database 140 in step S320.

The processor 110 inputs link attribute information and link group attribute information, among pieces of collected traffic information, to a first artificial intelligence model that is a link group-level ETA prediction model, and then analyzes data in real time in step S330.

Here, as the first artificial intelligence model, a transformer model (attention) may be used. The first artificial intelligence model may predict travel time (ETA) on a link group basis based on the input traffic information data, that is, speed, traffic volume, incident, and location information in step S340. When link group-level predicted travel time (ETA) is computed from the first artificial intelligence model, the processor 110 may convert the link group-level predicted travel time (ETA) into speed data, and output the speed data.

The processor 110 inputs the link attribute information and the link group attribute information to the second artificial intelligence model, and inputs the predicted travel time (ETA) output from the first artificial intelligence model to the second artificial intelligence model to analyze the input data in step S350.

The second artificial intelligence model may predict link-level traffic information from the link group-level predicted travel time (ETA) based on the input data in step S360. Here, the second artificial intelligence model may predict link-level traffic information based on a traffic information heatmap for a plurality of links included in the link group.

The processor 110 transmits predicted data, that is, the link-level predicted traffic information, to the traffic server 30 through the communication unit 130 in step S370. The traffic server 30 may store the received predicted traffic information, and may transmit the predicted traffic information to the route search server 20 in response to a request.

Furthermore, the processor 110 may store real-time data and predicted data for each future time point in step S380. The processor 110 may use computed data for re-training of the artificial intelligence model.

Therefore, the traffic information prediction apparatus and method according to an aspect of the present disclosure may set a link group including a plurality of links, analyze entry and exit of vehicles on a link group basis to predict traffic information, and convert the predicted traffic information into link-level information, thus improving the accuracy of prediction.

Further, the traffic information prediction apparatus and method according to the present disclosure may easily derive a pattern by analyzing real-time data on a link group basis, may easily predict traffic information, and may provide accurate traffic information, thus improving the ease and efficiency of route setting.

While the present disclosure has been described with respect to the specific embodiments illustrated in the attached drawings, these are only for illustrative purposes, and it will be apparent to those skilled in the art that various modifications and equivalent other embodiments may be made without departing from the scope of the technical field to which the disclosure pertains. Therefore, the technical scope of the present disclosure should be defined by the accompanying claims.

What is claimed is:

1. A traffic information prediction apparatus, comprising:
a communication unit configured to receive real-time traffic information data and past traffic information data; and
a processor configured to
set a link group including a plurality of links,
predict, using a first artificial intelligence model, a travel time for the link group based on the real-time traffic information data and the past traffic information data, and
predict, using a second artificial intelligence model, link-level traffic information based on the predicted travel time for the link group.

2. The traffic information prediction apparatus of claim 1, wherein the processor is configured to:
input traffic information data including speed, traffic volume, incident, and location information to the first artificial intelligence model and the second artificial intelligence model, and
input link group-level predicted travel time computed from the first artificial intelligence model to the second artificial intelligence model and then output link-level predicted traffic information.

3. The traffic information prediction apparatus of claim 1, wherein the processor computes the travel time for the link group by summing travel times for the plurality of links at an identical n-th time through the first artificial intelligence model.

4. The traffic information prediction apparatus of claim 1, wherein the processor computes a predicted speed for the link group by converting the travel time for the link group into a speed based on the first artificial intelligence model.

5. The traffic information prediction apparatus of claim 1, wherein the processor predicts the link-level traffic information using a traffic information heatmap for the plurality of links included in the link group based on the second artificial intelligence model.

6. The traffic information prediction apparatus of claim 1, wherein the processor inputs link attribute information comprising spatial information, link information, traffic information, and incident information and link group attribute information comprising length information, traffic information, and time information to the first artificial intelligence model and the second artificial intelligence model.

7. The traffic information prediction apparatus of claim 1, wherein the first artificial intelligence model and the second artificial intelligence model are implemented by modeling traffic information data based on an embedding module and a transformer module.

8. The traffic information prediction apparatus of claim 7, wherein the transformer module learns importance of each link, among the plurality of links included in the link group, based on a degree of influence on traffic condition prediction.

9. A traffic information prediction method, comprising:
predicting, by executing a first artificial intelligence model using a processor, a travel time for a link group including a plurality of links based on real-time traffic information data and past traffic information data; and
predicting, by executing a second artificial intelligence model using the processor, link-level traffic information based on the travel time for the link group.

10. The traffic information prediction method of claim 9, wherein, in the predicting of the travel time for the link group,
the processor computes the travel time for the link group by summing travel times for respective links at an identical n-th time, for the plurality of links included in the link group, through the first artificial intelligence model.

11. The traffic information prediction method of claim 9, wherein, in the predicting of the travel time for the link group,
the processor computes a predicted speed for the link group by converting the travel time for the link group into a speed based on the first artificial intelligence model.

12. The traffic information prediction method of claim 9, wherein, in the predicting of the link-level traffic information,
the processor predicts the link-level traffic information using a traffic information heatmap for the plurality of links included in the link group based on the second artificial intelligence model.

13. The traffic information prediction method of claim 9, further comprising:
inputting, by the processor, link attribute information comprising spatial information, link information, traffic information, and incident information and link group attribute information comprising length information, traffic information, and time information to the first artificial intelligence model and the second artificial intelligence model.

14. The traffic information prediction method of claim 13, wherein, in the inputting, the processor is configured to:
input traffic information data including speed, traffic volume, incident, and location information to the first artificial intelligence model and the second artificial intelligence model, and
input link group-level predicted travel time computed from the first artificial intelligence model to the second artificial intelligence model.

15. The traffic information prediction method of claim 9, wherein the first artificial intelligence model and the second artificial intelligence model are implemented by modeling traffic information data based on an embedding module and a transformer module.

16. The traffic information prediction method of claim 15, wherein the transformer module learns importance of each link, among the plurality of links included in the link group, based on a degree of influence on traffic condition prediction.

17. The traffic information prediction apparatus of claim 1, wherein the travel time is an estimated time of arrival (ETA).

18. The traffic information prediction method of claim 9, wherein the travel time is an estimated time of arrival (ETA).
